(19) United States
(12) Patent Application Publication
(10) Pub. No.: US 2005/0068584 A1
(43) Pub. Date: Mar. 31, 2005

(54) Image printing system

(75) Inventor: Yoshiki Kawaoka, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/946,103

(22) Filed: Sep. 22, 2004

(30) Foreign Application Priority Data
Sep. 25, 2003 (JP) NO.2003-333436

(51) Int. Cl. G06K 15/02; H04N 1/387; G06T 11/60; G10L 15/26

(52) U.S. Cl. 358/1.18; 382/100; 704/235

(57) ABSTRACT

An image printing system, comprising: an image data acquisition device of acquiring moving image data with voice data; a speech recognition device of performing speech recognition of the voice data to convert the voice data into a character string; a still image data extraction device of extracting still image data from the moving image data; a layout device of determining a layout of a printed output where the extracted still image data and the converted character string are arranged; and a printing device of printing the still image data and the character string in the determined layout.

### BACKGROUND OF THE INVENTION

1. Field of the Invention

The present invention relates to an image printing system, and in particular, to an image printing system which prints image data acquired from a recording medium, a network, etc.

2. Related Art

There are requests of wanting to also print characters with an image when printing the image shot and obtained with a camera etc. An image printing system which enables the print of characters with an image is provided for such requests. For example, a system is proposed, the system which independently displays an image and characters, which are to be printed, on an image display section and a character display unit respectively at the time of display, and superimposes the characters in the image and prints them at the time of printing so that a printed image may be formed satisfactorily in a range which is limited in a printing medium (refer to Japanese Patent Application Publication No. 2001-256011).

Another system is also proposed, the system which makes a user specify a still picture, which is extracted from moving images, a frame (material image), and the like, extracts the specified still picture from the moving images, and synthesizes and prints the extracted still image in the specified frame (refer to Japanese Patent Application Publication No. 2002-215772).

### SUMMARY OF THE INVENTION

Voice data accompanies plenty of moving image data. Voice data accompanies also some of still image data. Although this voice data accompanying image data is precious data relevant to the image data, it has been disregarded on the occasion of image printing. Alternatively, it has been necessary to perform image printing after reinputting characters as a character string. In this way, a conventional image printing system has a problem that voice accompanying an image is not effectively reused when printing the image.

The present invention was made in view of such a situation, and aims at providing an image printing system which can enjoy voice, accompanying an image, as characters together with the image.

In order to attain the above-mentioned object, a first aspect of the present invention is an image printing system comprising: an image data acquisition device of acquiring moving image data with voice data, a speech recognition device of performing speech recognition of the voice data to convert the voice data into a character string, a still image data extraction device of extracting still image data from the moving image data, a layout device of determining a layout of a printed output where the extracted still image data and the converted character string are arranged, and a printing device of printing the still image data and the character string in the determined layout.

Owing to this constitution, voice data accompanying moving image data is printed as a character string with the still image data extracted from the moving image data.

A second aspect of the present invention according to the first aspect further comprises a command input device of inputting a command which designates still image data to be extracted from the moving image data, and has such constitution that the still image data extraction device extracts still image data from the moving image data according to the inputted command.

Owing to this constitution, an image (still image data) which a user selects from in moving image data is printed with a character string corresponding to voice data.

A third aspect of the present invention according to the first aspect has constitution characterized in that the speech recognition device recognizes the start of a clause included in the voice data, and that the still image data extraction device extracts still image data corresponding to the recognized start of the clause.

Owing to this constitution, an extracted image (still image data) which is automatically selected on the basis of a speech recognition result from in moving image data is printed with a character string corresponding to voice data.

In addition, a fourth aspect of the present invention is an image printing system comprising: an image data acquisition device of acquiring still image data with voice data, a speech recognition device of performing speech recognition of the voice data to convert the voice data into a character string, a layout device of determining a layout of a printed output where the still image data and the converted character string are arranged, and a printing device of printing the still image data and the character string in the determined layout.

Owing to this constitution, voice data accompanying still image data is printed as a character string with the still image data.

Furthermore, a fifth aspect of the present invention according to any one of the first to fourth aspects has such constitution that the layout device arranges a character string in a space left after arrangement of still image data.

Moreover, a sixth aspect of the present invention according to any one of the first to fourth aspects has such constitution that the layout device arranges a character string by avoiding an area, which has a face, in still image data.

In addition, a seventh aspect of the present invention according to the sixth aspect has such constitution that the layout device arranges a character string in a balloon while arranging the balloon.

According to the present invention, it is possible to enjoy voice, accompanying an image, as characters together with the image.

### BRIEF DESCRIPTION OF THE DRAWINGS

FIG. 1 is a block diagram showing a conceptual schematic constitution of a printer to which the present invention is applied;

FIG. 2 is a block diagram showing an example of a specific constitution of a printer to which the present invention is applied;

FIG. 3 is a diagram showing an example of a touch screen monitor;

FIG. 4 is a flowchart showing the operation of a printer to which the present invention is applied;

FIGS. 5A and 5B are diagrams showing examples of prints; and

FIGS. 6A to 6D are diagrams showing examples of output layout formats.

### DETAILED DESCRIPTION OF THE PREFERRED EMBODIMENTS

Best embodiments of an image printing system according to the present invention will be described below in detail according to accompanying drawings.

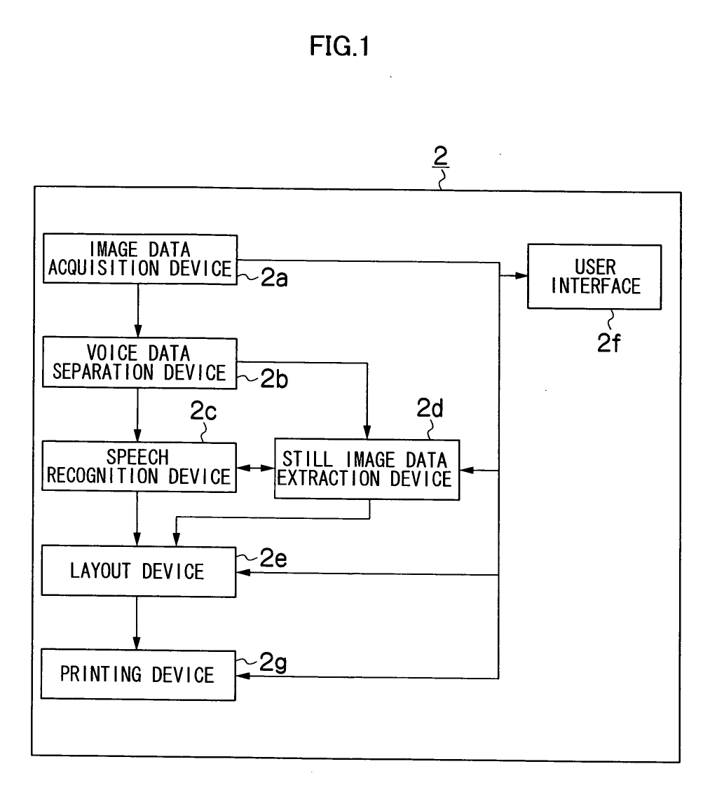

FIG. 1 is a block diagram conceptually showing a schematic constitution of an image printing system 2 of one embodiment according to the present invention.

As shown in FIG. 1, the image printing system 2 is constituted by including an image data acquisition device 2a, a voice data separation device 2b, a speech recognition device 2c, a still image data extraction devices 2d, a Layout device 2e, a user interface 2f, and a printing device 2g.

The image data acquisition device 2a acquires image data with voice data from a recording medium, a network, or the like. Here, there are moving image data and still image data in the image data. In addition, the image data with voice data includes data that voice data is integrally built in image data and is stored in the same file, or data that image data and voice data are stored in different files, which are associated with file names etc. In addition, an acquisition source of image data is limited to neither a recording medium nor a network especially. For example, it is also sufficient to acquire image data by direct communicating with a digital camera or a camera cellular phone. The format of image data or voice data is not limited especially. For example, moving image data includes data recorded in a motion JPEG (Joint Photographic Expert Group) form.

The voice data separation device 2b separates voice data from image data when voice data is integrally built in image data acquired by the image data acquisition device 2a. In addition, it is not necessary to perform separation when image data and voice data which are acquired by the image data acquisition device 2a are stored in different files.

The speech recognition device 2c performs speech recognition of voice data and converts it into a character string (this is also called a “voice text”). A widely known algorithm is used as a fundamental algorithm of speech recognition. In addition, it is satisfactory to use an algorithm suitable to each language, for example, a Japanese speech recognition algorithm when a Japanese speaker is a target, or an English speech recognition algorithm when an English speaker is a target.

The still image data extraction device 2d extracts still image data from moving image data. As for the extraction aspect, there are various kinds of aspects and examples of the extraction aspects will be explained in full detail later.

The layout device 2e determines a layout for a printed output where a character string, converted by the speech recognition device 2c, and still image data are arranged, and creates image data for the printed output.

The user interface 2f can input various kinds of commands such as an acquisition command of image data, a selective command of image data, a selective command of still image data to be extracted from moving image data in the case that the acquired image data is moving image data, a command relating to a layout of a printed output, and a print command. In addition, the user interface 2f can perform various kinds of display such as list display of image data, playback display of image data, display of a speech recognition result, and display of a layout result. A specific constitution of the user interface 2f is not limited especially, but, besides a touch screen monitor described later, it is also satisfactory to constitute the user interface 2f by I/O devices generally used as peripheral devices of a personal computer such as a keyboard, a mouse, and an LCD (liquid crystal display unit), or to use a voice input/output device. In addition, as for commands, it is also sufficient to fetch print ordering information, specified beforehand, from a recording medium, a network, or the like.

The printing device 2g executes the print of the image and character string with the layout determined by the layout device 2e. The printing medium is not limited especially and is selected according to usage such as a roll sheet, a sheet-like paper, a postcard, or a sticker.

In addition, the image printing system 2 actually comprises a CPU (central processing unit) which executes image print processing according to a predetermined program (image print program). Each processing of image data acquisition, voice data separation, speech recognition, still image data extraction, layout, command inputting, printing, and the like are performed by the integrated control of the CPU. Hereafter, this will be described.

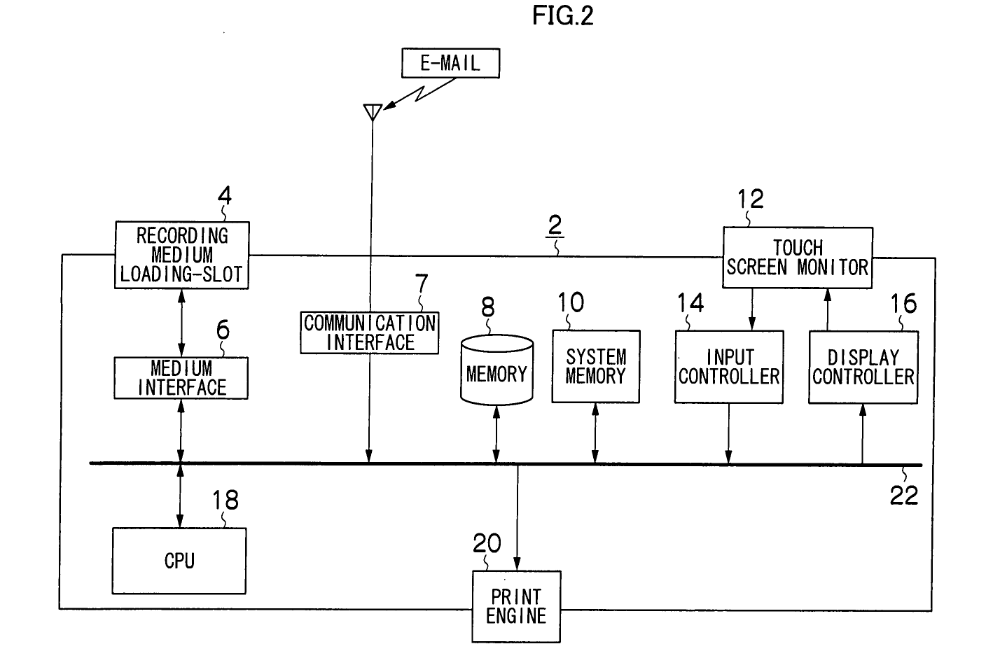

FIG. 2 is a block diagram showing a specific constitutional example of a printer having a function as an image printing system of one embodiment according to the present invention. In FIG. 2, since a printer 2 is equivalent to the image printing system 2 in FIG. 1, the same reference numeral is assigned. In addition, although the printer 2 in FIG. 2 and the image printing system 2 in FIG. 1 are made the same, it is also sufficient as another aspect to adopt such constitution as comprises an image processing controller which executes image data acquisition, voice data separation, speech recognition, still image data extraction, and outputting of the image data for layout and printing, and a printing system which prints the image data for printing which received from this image processing controller.

The printer 2 shown in FIG. 2 mainly comprises a recording medium loading-slot 4, a media interface 6, a communication interface 7, memory 8, system memory 10, a touch screen monitor 12, an input controller 14, a display controller 16, a CPU 18, a print engine 20, and a bus 22.

This printer 2 has the recording medium loading-slot 4 into which a recording medium currently used in a digital camera or a cellular phone is inserted. Hence, it is possible to fetch moving image file (moving image data) or a still image file (still image data) from the recording medium inserted in this recording medium loading slot 4.

After the recording medium is inserted into the recording medium loading-slot 4, the moving image file or still image file which is recorded on the recording medium is sent to the memory 8 through the medium interface 6 and bus 22 while following a command of the CPU 18.

In addition, the printer 2 can fetch a moving image file (moving image data) or a still image file (still image data) from a network, a digital camera, a cellular phone, etc. through the communication interface 7. In regard to a communication aspect, there are various kinds of aspects, and both of wireless and cabled communications are usable. The Internet may be accessed. For example, E-mail with a moving image file or a still image file is received, the received E-mail is sent to the memory 8 through the communication interface 7 and bus 22 with following the command of the CPU 18.

The memory 8 comprises RAM, and temporarily stores image data acquired through the medium interface 6 or communication interface 7, image data for display which is generated by the CPU 18 described later, image data for printing, information necessary for the operation of a program, etc.

The system memory 10 comprises ROM, and stores a program, information necessary for program execution, etc.

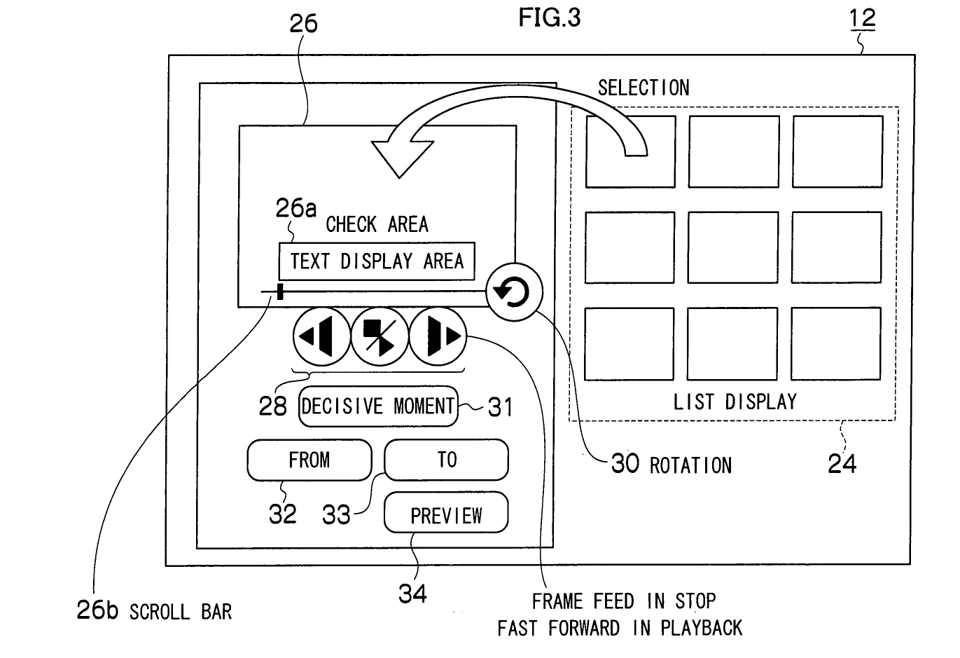

The touch screen monitor 12 has an operation unit and a display screen (see FIG. 3 for detail), and the display controller 16 controls the display. In addition, when the operation unit of the touch screen monitor 12 is operated, the input controller 14 operates and an input is executed.

The CPU 18 not only performs the integrated control of respective parts of the printer 2, but also performed various types of processing such as separation processing of voice data and image data, speech recognition processing of voice data, extraction processing of still image data from moving image data, generation processing of image data for display, and layout of a printed output, and generation processing of image data for printing. In addition, the CPU 18 also extends image data compressed in a motion JPEG form and recorded.

The print engine 20 executes printing.

If we simply explain the correspondence of the components, shown in FIG. 2, and the components in FIG. 1, the image data acquisition device 2a is constituted by the media interface 6, communication interface 7, and the like, the voice data separation device 2b, speech recognition device 2c, still image data extraction device 2d, and layout device 2e are constituted by the CPU 18, memory 8, and the like, the user interface 2f is constituted by the touch screen monitor 12 and the like, and the printing device 2g is constituted by the print engine 20.

In addition, it is possible to install the image print program, executed by the CPU 18, in the printer 2 by setting CD-ROM, which records this image print program, in a CD-ROM drive not shown. It is also sufficient to download the image print program via a network from a server providing the image print program.

FIG. 3 is a diagram showing the operation unit and display screen of the touch screen monitor 12. A list display area 24 where the list display of image files is performed is formed in the right side on the touch screen monitor 12. A check area 26 is formed in the upper left portion of the touch screen monitor 12, and performs the playback display (image display) of a selected image file, and the like. A text display area 26a is provided in the check area 26, and displays a character string (voice text) converted from voice data by speech recognition. A scroll bar 26b is provided in the bottom of the check area 26, and shows where a scene (frame) currently displayed in playback is in the entire moving image file concerned. Moving image control buttons 28 are formed in the lower part of the check area 26. The moving image control buttons 28 comprise respective return, start/stop and fast-forward buttons. When the fast forward button is pushed during display stop, operation becomes a frame feed mode, and when pushed during image playback, the operation becomes a fast-forward mode. A rotation button 30 is formed in the lower right corner of the check area 26. The portrait or landscape orientation of a display image is performed by operating the rotation button 30.

Under the moving image control buttons 28, a “Decisive Moment” button 31, a “From” button 32, a “To” button 33, and a “Preview” button 34 are formed. As for the “Decisive Moment” button 31, by pushing this “Decisive Moment” button 31 when a user wants to specify a frame (still image data) currently displayed on the check area 26 during the playback of a moving image file, the frame (still image data) currently displayed is specified as a print object. The “From” button 32 and “To” button 33 are buttons for setting an actually print start point, and an end point. When the start point and end point are not set, it is regarded that the head of a moving image file and the tail are specified respectively. It is possible to push the “Decisive Moment” button 31, and consecutively to push at least one of the “From” button 32 and “To” button 33. In this case, frames (still image data) in a range which include the specific image at a decisive moment and are specified with the “From” button 32 and/or “To” button 33 are made print objects. The “preview” button 34 makes it possible to check the arranged image data for printing before actual printing by pushing this button.

In addition, it is possible to set the layout format and the number of frames of printed outputs with manual operation buttons not shown, and formats of layouts that the number of frames are shown are beforehand stored in the system memory 10. Hence, a user selects a format for printing by operating the above-mentioned manual operation buttons. When performing the selection, the user can select a favorite layout by making a layout format displayed in the check area 26.

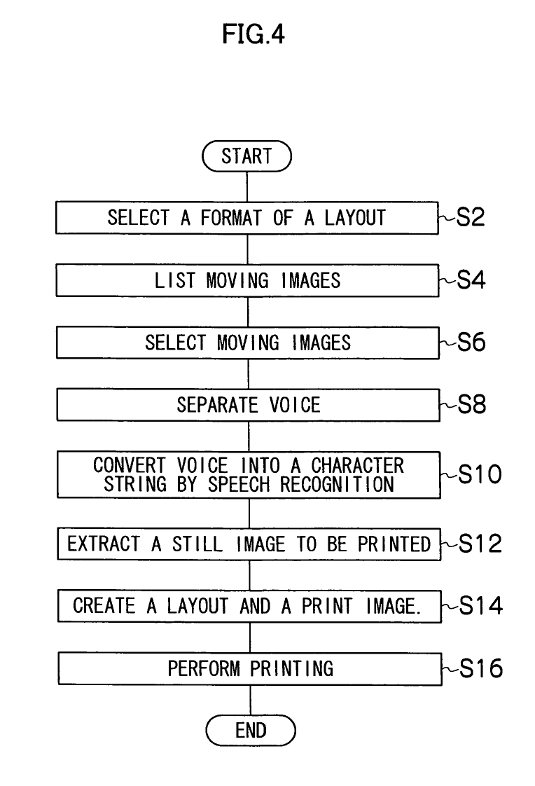

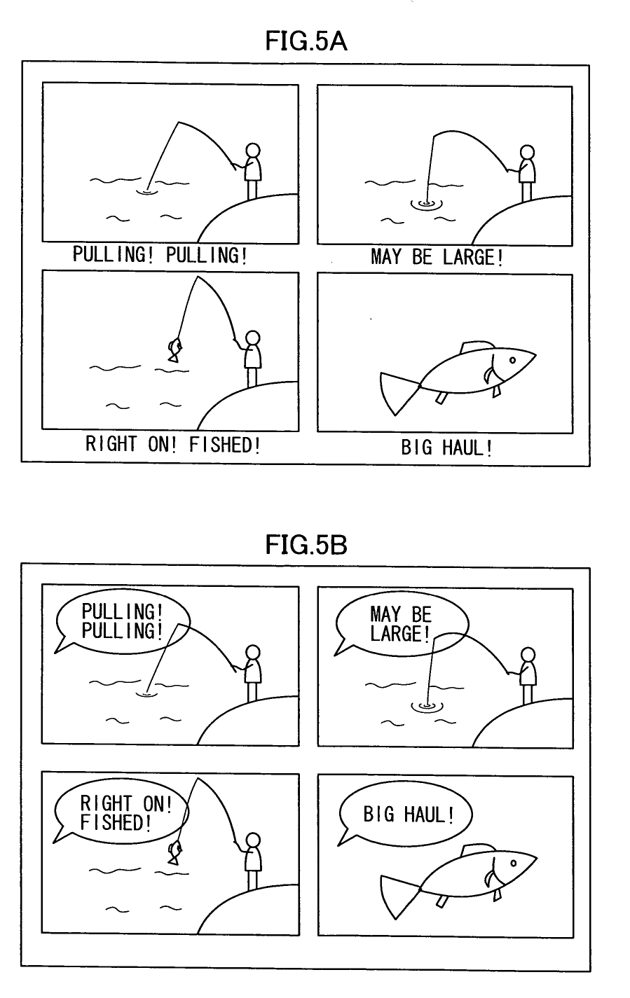

Hereinafter, the processing of acquiring moving image data with voice data by the printer 2 installed in a print shop, and performing image printing with a voice text will be explained. The outline of a flow of this image print processing is shown in the flowchart in FIG. 4. FIGS. 5A and 5B are explanatory diagrams used for the explanation of image print processing, and show examples given the image printing by the printer 2 on the basis of the moving image data with voice data where situations of fishing are recorded with voice.

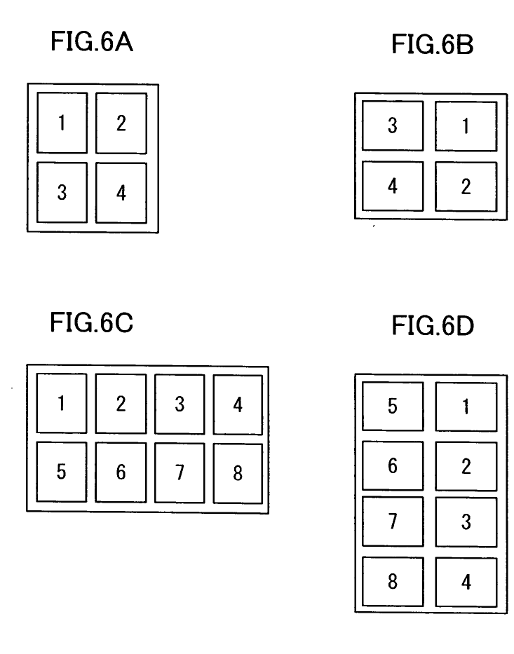

First, a user selects a format of a print output layout by operating the selection operation buttons (not shown) of the touch screen monitor 12 (S2). Several kinds of formats are stored beforehand in the system memory 10. For example, the formats shown in FIGS. 6A to 6D are stored. FIGS. 6A and 6B show a portrait format of such quadrant printing that four frames are printed on one sheet of print paper, and a landscape format respectively. In addition, FIGS. 6C and 6D show a portrait format of such octant printing that eight frames are printed on one sheet of print paper, and a landscape format respectively. It is also satisfactory to provide formats of full size printing (one frame), bisectional printing (two frames), hexadecasectional printing (16 frames) besides examples shown in FIGS. 6A to 6D. In addition, it is selectable in arrangement of a character string such as arrangement of a character string, obtained by speech recognition, in a space other than an image area as shown in FIG. 5A, or arrangement of a character string, obtained by speech recognition, in a balloon while avoiding an area, which has a face, in an image as shown in FIG. 5B.

When a recording medium is inserted in the recording medium loading slot 4, a list of moving image files currently recorded on the recording medium is displayed on the list display area 24 of the touch monitor panel 12 if a plurality of moving image files (moving image data) exist in the recording medium (S4). Here, a representative frame (for example, a first frame of a moving image file) of each moving image file is displayed on the list display area 24. In addition, when only one moving image file exists in a recording medium, only the representative frame of this moving image file is displayed on the list display area 24.

When a user operates the selection operation buttons (not shown) of the touch screen monitor 12, a moving image file to be printed is selected from a list (S6). It is possible to replay and check the content of the selected moving image file by the operation of the moving image control buttons 28 of the touch screen monitor 12. In addition, it is also possible to select a plurality of moving image files from the list. When another moving image file is selected while replaying a certain moving image file, the moving image file newly selected is replayed.

The CPU 18 separates voice data from the selected moving image file with voice data (S8), and performs speech recognition of this separated voice data to converts the voice data into a voice text (character string) (S10).

In addition, according to the format selected at step S2, the CPU 18 extracts the still image data with the number of frames necessary for a printed output from the moving image data (S12). There are various kinds of extraction aspects of these still image data such as first and second extraction aspects which are explained below.

In the first extraction aspect, the touch screen monitor 12 receives the selection of the still image data to be extracted. For example, a user pushes the “From” button 32 and “To” button 33 to specify a print starting point and a print end point. In a specified print section, that is, a section from the print starting point to the print end point, still image data which corresponds to frames (for example, four frames in the case of quadrant printing) of the format selected at step S2 is extracted in equal intervals to be made a print object, and the remainder is skipped. In addition, when a user does not specify the print starting point with the “From” button 32, it is regarded that the first frame of the moving image file or the frame after the predetermined frame (or the predetermined period) is specified with the “To” button 33. Furthermore, when the user does not specify the end point, it is regarded that the last frame or the frame before the predetermined frame (or the predetermined period) of the moving image file is specified. When a user does not specify the print starting point and print end point by pushing the “From” button 32 and “To” button 33, it is regarded that the entire section in the moving image file is specified. Then, still image data which corresponds to the specified number of frames is extracted in equal intervals from the entire section to be made a print object, and the remainder is skipped. In addition, it is also acceptable to extract the predetermined number of frames while weighting scenes from the print starting point, and to skip the remaining frames. In addition, it is also acceptable to specify the still image data to be extracted by pushing the “Decisive Moment” button 31 of the touch screen monitor 12. For example, it is also acceptable to specify a frame (central point), which becomes a center of a print section, by pushing the “Decisive Moment” button 31 and to extract still image data while making frames in predetermined time intervals before and after this central point a print object.

Moreover, the CPU 18 estimates a character string corresponding to the still image data extracted in the entire voice text converted by the speech recognition. In addition, the character string estimated to correspond to the frame displayed in the check area 26 of the touch screen monitor 12 is displayed on the text display area 26a in this check area 26. In this way, a character string estimated to correspond to each still image data is extracted out of the entire tone voice text. For example, in the case of FIG. 5A, four frames selected with the touch screen monitor 12 are extracted from the moving image data where the situation of performing fishing is recorded with voice, and character strings (“Pulling, pulling!”, “May be large”, “Right on, fished!”, and “Big haul”) estimated to correspond to respective frames are extracted. In the case of FIG. 5A, actually,“!” and “.” are inserted. In addition, in the speech recognition at step S10, the start of each clause is detected according to a widely known speech recognition algorithm. Moreover, by comparing elapsed time of each extraction frame from a first frame of the moving image file with elapsed time of each clause from the first frame of the moving image file, matching of each extracted frame with each clause is performed. In addition, it is also possible to unite a plurality of clauses into one group by evaluating the relevance of clauses.

In a second extraction aspect, the still image data which the CPU 18 should extract are selected on the basis of a speech recognition result in the CPU 18. Thus, the still image data is extracted automatically. In addition, in the speech recognition at step S10, as explained in the first aspect, the start of each clause is detected according to a widely known speech recognition algorithm. Moreover, by comparing elapsed time of each clause from the first frame of the moving image file with elapsed time of each frame from the first frame of the moving image file, the matching of each clause with each frame is performed. In addition, it is also possible to unite a plurality of clauses into one group by evaluating the relevance of clauses. Then, the still image data with frames corresponding to each clause is extracted from the moving image file. Here, the selection of the still image data may not be fully automatic, but may be semiautomatic. For example, it is also sufficient to display the still image data (here, this is a print candidate) selected by the CPU 18 in the check area 26 of the touch screen monitor 12, and to make a user determine whether the data is to be actually printed. In addition, it is also sufficient to enable the fine adjustment of selection of frames, which are to be actually printed, by shifting target frames before and after the frames, selected by the CPU 18, with the moving image control buttons 28 of the touch screen monitor 12.

By the way, generally, in the original sound voice data separated from moving image data, voice which a user does not expect may be also included. For example, although it is expected that only the voice of a camera person taking an image of a subject, or a person who was a subject is printed, the voice of a third person who was at the back, or surrounding-noise may be included in original sound voice data. It is desirable to eliminate such a third person's voice, and surrounding-noise. Then, processing to be performed is, for example, that only a section where a voice level in voice data is large is converted into a character string when performing speech recognition, and the section is made the character string to be a print object.

A voice text corresponding to each still picture data is arranged by the CPU 18 so as to be arranged in a space near each still picture image or in a still picture image, and image data for printing is created (S14). It is possible to check the image data for printing beforehand in the check area 26 of the touch screen monitor 12 by pushing the preview button 34 of the touch screen monitor 12 if needed.

The created image data for printing is transferred to the print engine 20, and is printed on predetermined print paper (S16).

In the print example shown in FIG. 5A, still images are arranged in the quadrant printing format, and a voice text corresponding to each still image is arranged at a space near the still image.

In the print example shown in FIG. 5B, still images are arranged in the quadrant printing format, and each voice text is arranged while avoiding an area, which has a face, in the still image. The CPU 18 recognizes this face image. Then, a balloon is arranged while avoiding an area which has a face, and the voice text corresponding to each still picture is arranged in this balloon.

In addition, although the case that still image data extracted from moving image data with voice data is printed with a voice text is exemplified in the above-mentioned explanation using FIG. 4, the present invention is not restricted to this. The present invention is also applicable to the case of acquiring still image data with voice data, converting the voice data into a voice text, and printing the still picture image with the voice text.

Furthermore, the present invention is not limited to the above-mentioned embodiments or drawings, and it is apparent that various kinds of improvement or modification can be performed within the scope of the present invention.

For example, in regard to the speech recognition, it is also satisfactory to perform such improvement as performs person identification and converts only a specific person's voice into a character string. Moreover, in regard to the matching of a speech recognition result and each frame in moving image data (still image data), it is also satisfactory to perform such improvement as enables various kinds of adjustments with a user interface according to the accuracy of speech recognition and matching, or performs speech recognition and matching according to various kinds of conditions by setting these various kinds of conditions beforehand.

1. An image printing system, comprising:
an image data acquisition device of acquiring moving image data with voice data;
a speech recognition device of performing speech recognition of the voice data to convert the voice data into a character string;
a still image data extraction device of extracting still image data from the moving image data;
a layout device of determining a layout of a printed output where the extracted still image data and the converted character string are arranged; and
a printing device of printing the still image data and the character string in the determined layout.

2. The image printing system according to claim 1, further comprising:
a command input device of inputting a command which designates still image data to be extracted from the moving image data,
wherein the still image data extraction device extracts still image data from the moving image data according to the inputted command.

3. The image printing system according to claim 1, wherein the speech recognition device recognizes start of a clause included in the voice data; and
wherein the still image data extraction device extracts still image data corresponding to the recognized start of the clause.

4. The image printing system according to claim 1, wherein the layout device arranges a character string in a space left after arrangement of still image data.

5. The image printing system according to claim 1, wherein the layout device arranges a character string while avoiding an area, which has a face, in still image data.

6. The image printing system according to claim 5, wherein the layout device arranges a character string in a balloon while arranging the balloon.

7. An image printing system, comprising:
an image data acquisition device of acquiring still image data with voice data;
a speech recognition device of performing speech recognition of the voice data to convert the voice data into a character string;
a layout device of determining a layout of a printed output where the still image data and the converted character string are arranged; and
a printing device of printing the still image data and the character string in the determined layout.

8. The image printing system according to claim 7, wherein the layout device arranges a character string in a space left after arrangement of still image data.

9. The image printing system according to claim 7, wherein the layout device arranges a character string while avoiding an area, which has a face, in still image data.

10. The image printing system according to claim 9, wherein the layout device arranges a character string in a balloon while arranging the balloon.
